(19) United States
(12) Patent Application Publication
(10) Pub. No.: US 2026/0162634 A1
(43) Pub. Date: Jun. 11, 2026

(54) FOLDABLE CONGA SUPPORT

(71) Applicant: REMARKABLE Company, Taichung City (TW)

(72) Inventor: Ming Yi Chang, Taichung City (TW)

(21) Appl. No.: 19/074,226

(22) Filed: Mar. 7, 2025

(30) Foreign Application Priority Data
Dec. 5, 2024 (TW) 113147319

(51) Int. Cl. G10D 13/10

(52) U.S. Cl. CPC G10D 13/28

(57) ABSTRACT

A foldable conga stand includes a plurality of leg units and connecting units each connected between the adjacent leg units to form a stand for holding a conga. The leg units each have a support unit thereon and include a main rod fixedly connected to the connecting unit. The main rod has an upper joint portion. The support unit has a first movable elbow portion. The first movable elbow portion is pivotally connected to the upper joint portion so that the support unit is pivotal relative to the main rod. The support unit further has a support arm extending from the first movable elbow portion and an elongate support member pivoted to a distal end of the support arm. The support member is pivotable relative to the support arm. The foldable conga stand can be used for holding a conga stably and can be folded to be small in size.

### FIELD OF THE INVENTION

The present invention relates to a stand structure for percussion instruments, and more particularly, to a foldable conga stand.

### BACKGROUND OF THE INVENTION

Congas are a type of percussion instruments. The lower section of a conga is tapered downward, so the conga is in the shape of a barrel. Therefore, the design of a conga stand needs to take into account how to achieve a stable support without tipping over.

The conga stand disclosed in the U.S. Patent Application Publication No. US2006/0185496 is composed of a fixed ring and a plurality of legs on the fixed ring. Although it can achieve the basic function of holding a conga, the support is not very stable. Besides, the conga stand is fixed in size to fit a specific conga, and it cannot be folded so it takes up a lot of space when stored.

The conga stand disclosed in U.S. Pat. Nos. 5,335,575 and 7,588,228 includes leg members and slide members that can slide up and down along the leg members. The leg members of the conga stand are collapsible, so as to reduce the size of the conga stand. The positions of the slide members are adjustable, so as to change the diameter of supporting a conga. However, this folding structure is quite complex. In actual use, the width of the leg members after being unfolded is interacted with the diameter of supporting the conga, so it is not easy to adjust the leg members for holding the body of the conga tightly.

The conga stand disclosed in U.S. Pat. No. 6,040,514 includes a carrier for placement of a conga. A plurality of adjustable position blocks are slidably connected to the carrier. By adjusting the position blocks to hold the lower end of the conga, the conga stand is used for holding congas of different sizes. However, the strength of this conga stand to hold the body of the conga is too small, and the support position is too low, resulting in poor support stability. Besides, the carrier is not adjustable in height, so the conga stand is not practical.

### SUMMARY OF THE INVENTION

The primary object of the present invention is to provide a foldable conga stand, which can be folded quickly and is able to adjust the support diameter of the conga stand with ease and ensures the support stability.

In order to achieve the foregoing object, the present invention provides a foldable conga stand. The foldable conga stand comprises at least three leg units. The leg units each have a support unit thereon. A connecting unit is connected between every adjacent two of the leg units.

The leg units each include a main rod fixedly connected to the connecting unit. A pole is connected to a lower end of the main rod. An upper end of the main rod has an upper joint portion. The support unit has a first movable elbow portion. The first movable elbow portion of the support unit is pivotally connected to the upper joint portion so that the support unit is pivotal relative to the main rod. The support unit further has a support arm extending from the first movable elbow portion and an elongate support member pivoted to a distal end of the support arm. The support member is pivotable relative to the support arm.

Preferably, a first locking member consisting of a locking bolt and a nut is inserted through the upper joint portion and the first movable elbow portion, so that the first movable elbow portion and the upper joint portion are pivotally connected to each other.

Preferably, the lower end of the main rod has a lower joint portion. An upper end of the pole has a second movable elbow portion that is connected to the lower joint portion. A second locking member consisting of a locking bolt and a nut is inserted through the lower joint portion and the second movable elbow portion, so that the second movable elbow portion and the lower joint portion are pivotally connected to each other.

Preferably, the support member is in the form of a plate having a U-shaped cross-section. A return spring is provided at a position where the support member is pivotally connected to the support arm. The return spring is configured for pushing the support member to form an inclined angle between the support member and the support arm.

### BRIEF DESCRIPTION OF THE DRAWINGS

FIG. 1 is a perspective view of the present invention;

FIG. 2 is an exploded view of the present invention;

FIG. 3 is a schematic view of the present invention in a use state;

FIG. 4 is a partial, enlarged view of FIG. 3;

FIG. 5 is a schematic view of the present invention when in use, wherein the telescopic poles are pulled outward for adjusting the height of the conga stand; and

FIG. 6 is a schematic view of the present invention in a folded state.

### DETAILED DESCRIPTION OF THE PREFERRED EMBODIMENTS

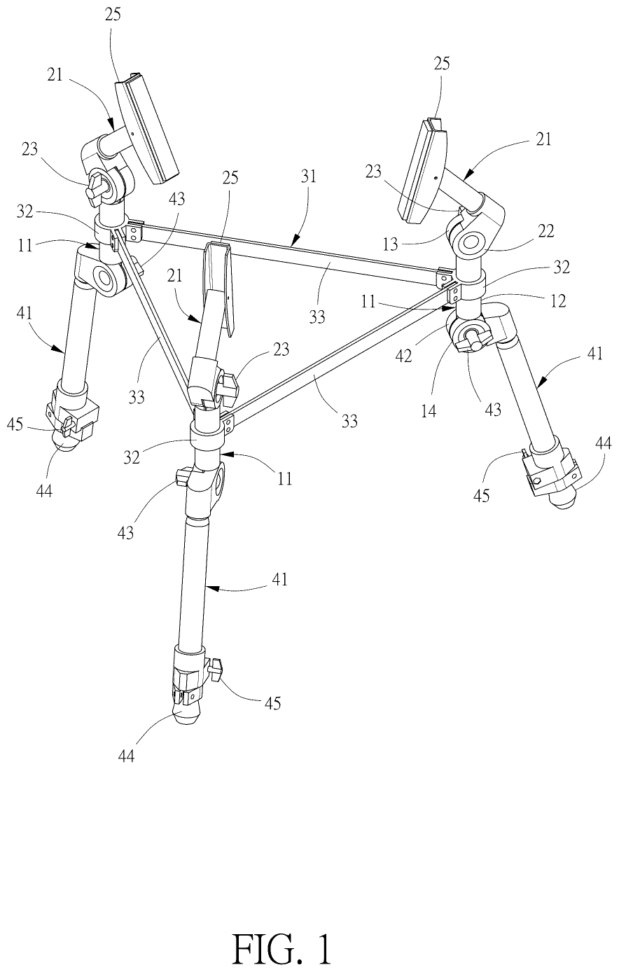

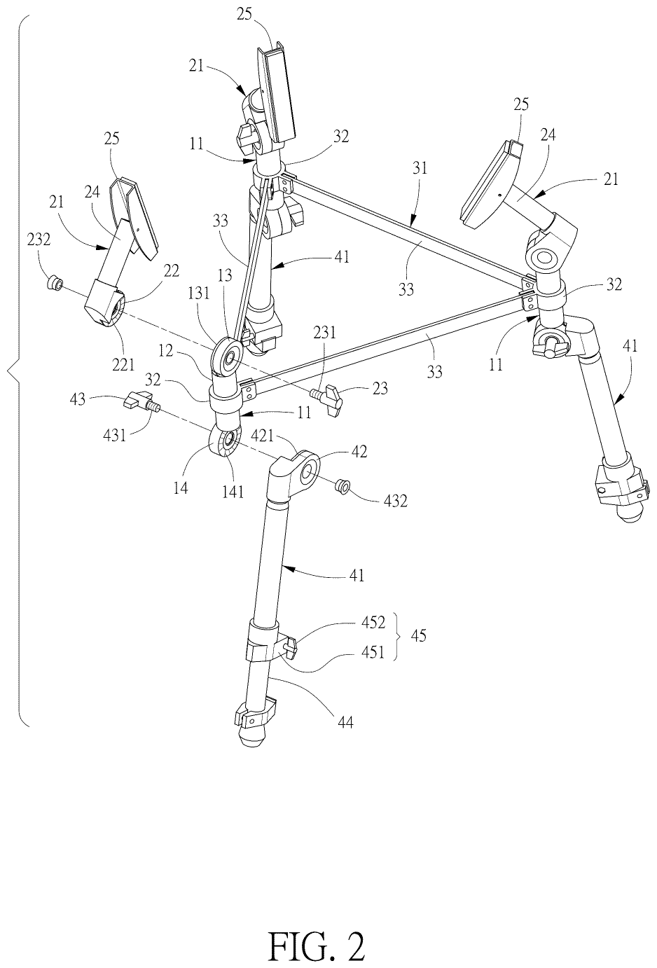

As shown in FIG. 1 through FIG. 4, the present invention provides a foldable conga stand. In this embodiment, the foldable conga stand comprises three leg units 11 as an example. A support unit 21 is connected to each of the leg units 11. A connecting unit 31 is connected between every adjacent two of the leg units 11.

Each leg unit 11 includes a main rod 12 fixedly connected to the connecting unit 31. The connecting unit 31 includes a clamping ring 32 fixed on the main rod 12 and a connecting rod 33 transversely connected between the clamping rings 32 on the main rods 12 of the adjacent leg units 11, such that the leg units 11 are erected into a tripod for holding a conga 90. A pole 41 is connected to the lower end of the main rod 12. The upper end of the main rod 12 is expanded to form a disc-shaped upper joint portion 13. One end of the support unit 21 is expanded to form a first movable elbow portion 22 that is connected to the upper joint portion 13. Mating end faces of the upper joint portion 13 and the first movable elbow portion 22 have annular toothed segments 131, 221 to mesh with each other. A first locking member 23 consisting of a locking bolt 231 having a knob and a nut 232 is inserted through the upper joint portion 13 and the first movable elbow portion 22, so that the first movable elbow portion 22 and the upper joint portion 13 are pivotally connected to each other. When the first locking member 23 is not tightened, the support unit 21 can be pivoted relative to the main rod 12. When the first locking member 23 is tightened, the annular toothed segments 131, 221 of the upper joint portion 13 and the first movable elbow portion 22 are meshed with each other, thereby positioning the support unit 21 after being pivoted and adjusted.

Furthermore, the support unit 21 has a support arm 24 extending from the first movable elbow portion 22 and an elongate support member 25 pivoted to the distal end of the support arm 24. The support member 25 is pivotable relative to the support arm 24. The support member 25 is in the form of a plate having a U-shaped cross-section. A return spring 26 is provided at a position where the support member 25 is pivotally connected to the support arm 24. The return spring 26 is configured for pushing the support member 25 to form an inclined angle between the support member 25 and the support arm 24. One end face of the support member 25, facing away from the support arm 24, forms a support area 251 for holding the outer peripheral surface of the conga 90. An anti-slip pad 27 made of a soft material is provided on the support area 251.

The lower end of the main rod 12 is expanded to form a disc-shaped lower joint portion 14. The upper end of the pole 41 is expanded to form a second movable elbow portion 42 that is connected to the lower joint portion 14. Mating end faces of the lower joint portion 14 and the second movable elbow portion 42 have annular toothed segments 141, 421 to mesh with each other. A second locking member 43 consisting of a locking bolt 431 having a knob and a nut 432 is inserted through the lower joint portion 14 and the second movable elbow portion 42, so that the second movable elbow portion 42 and the lower joint portion 14 are pivotally connected to each other. When the second locking member 43 is not tightened, the pole 41 can be pivoted relative to the main rod 12. When the second locking member 43 is tightened, the annular toothed segments 141, 421 of the lower joint portion 14 and the second movable elbow portion 42 are meshed with each other, thereby positioning the pole 41 after being pivoted and adjusted. Furthermore, the pole 41 is in the form of a hollow tube. A telescopic pole 44 is telescoped in the pole 41. The telescopic pole 44 is slidable relative to the pole 41. An annular fastening member 45 is provided at a position where the telescopic pole 44 is telescoped to the pole 41. The annular fastening member 45 includes a fastening ring 451 and a locking bolt 452 having a knob. After the extension length of the telescopic pole 44 relative to the pole 41 is adjusted, the fastening ring 451 is locked by the locking bolt 452 to secure the telescopic pole 44. The height of the conga stand for holding the conga can be adjusted easily and quickly.

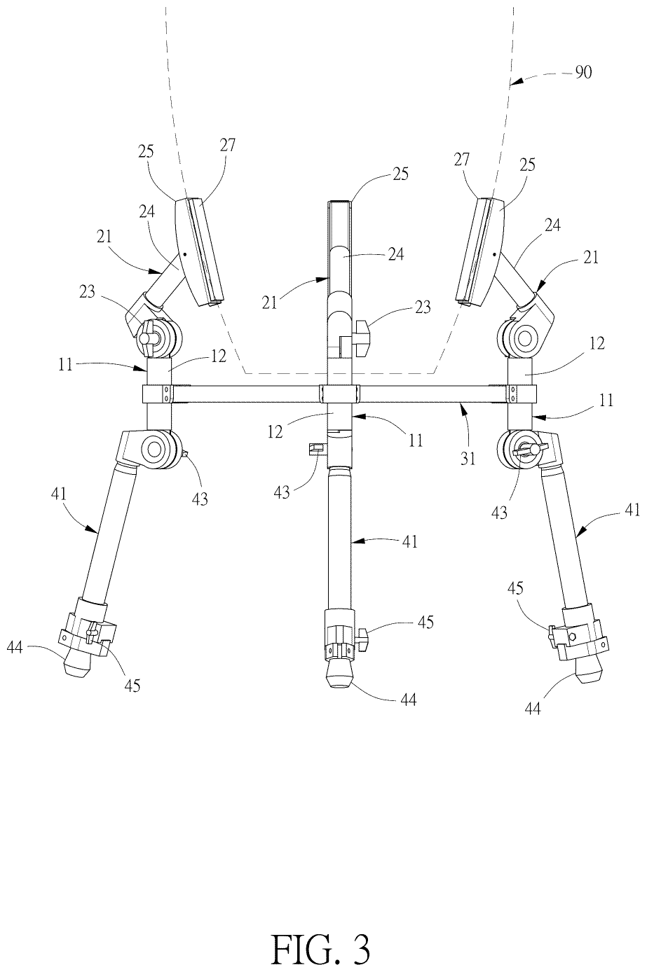

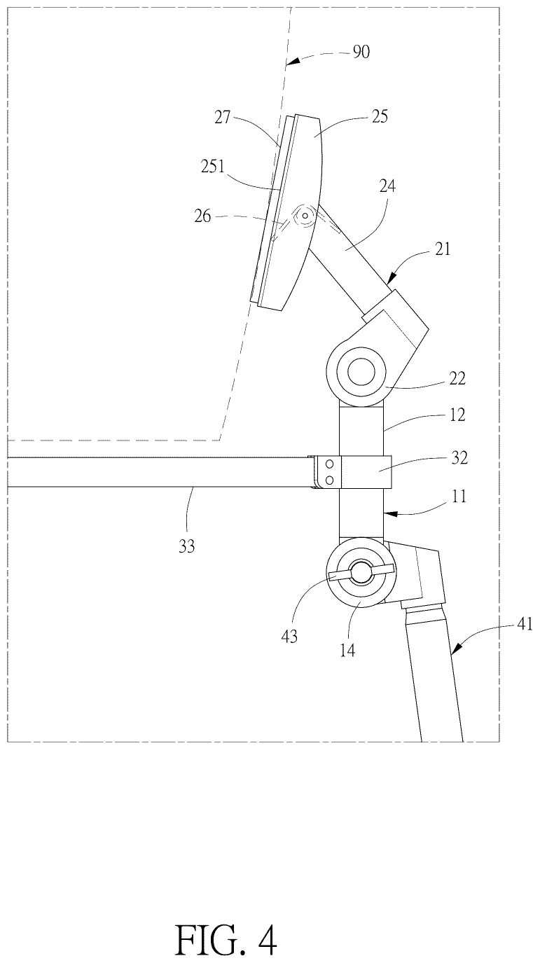

In actual use, as shown in FIG. 3 and FIG. 4, the user rotates and locks the first locking member 23 on each leg unit 11 to adjust the pivot angle of the support arm 24 of the support unit 21 for the support member 25 on the support arm 24 of each support unit 21 to hold the outer peripheral surface of the conga 90. Through the return spring 26 to push the support member 25, the anti-slip pad 27 on the support member 25 is in contact with the peripheral surface of the conga 90, so as to hold the conga stably. The conga stand provided by the present invention is designed in such a way that the support unit 21 on each leg unit 11 can be pivoted relative to the main rod 12, such that the diameter for holding the conga can be changed easily and quickly by adjusting the pivot angle of the support unit 21. Thus, the conga stand can be used for holding congas 90 with different sizes.

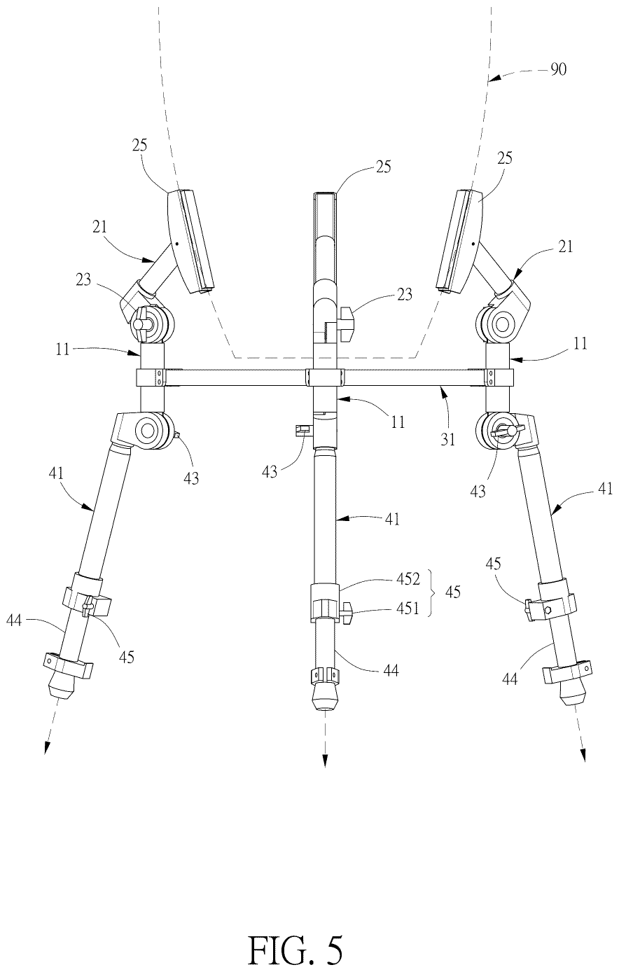

Furthermore, the present invention provides the function of adjusting the height of the conga stand for holding a conga. As shown in FIG. 5, in actual use, the fastening ring 451 can be loosened by unlocking the locking bolt 452 on the pole 41. After that, the telescopic pole 44 telescoped in each pole 41 is pulled outward to the required extension length according to the actual need. Then, the locking bolt 452 on each pole 41 is tightened for the fastening ring 451 to secure the telescopic pole 44 again. The height of the conga stand for holding the conga can be adjusted easily and quickly to suit different percussion requirements. Besides, the action of adjusting the height of the conga stand will not interfere with the diameter of the support units 21 for holding the conga, which is quite convenient.

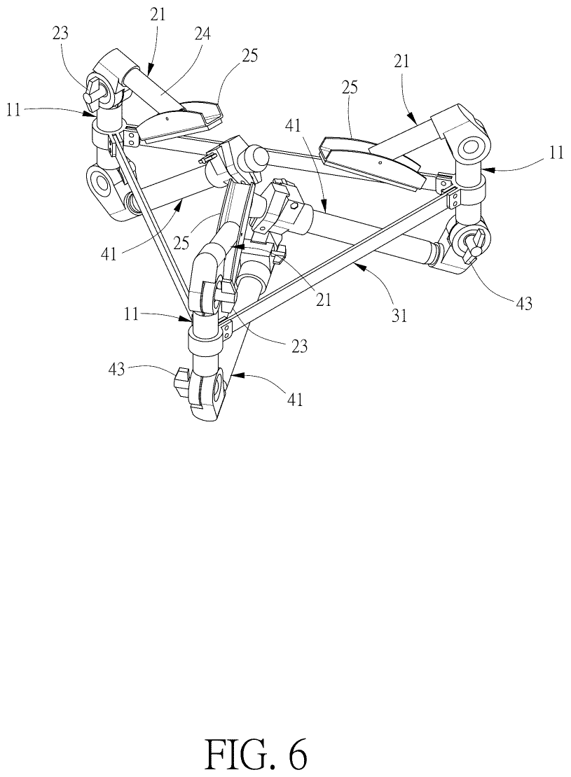

In addition, in the foldable conga stand provided by the present invention, the upper joint portion 13 and the lower joint portion 14 on both ends of the main rod 12 are pivotally connected to the first movable elbow portion 22 of the support unit 21 and the second movable elbow portion 42 of the pole 41. Therefore, by unlocking the first locking member 23 and the second locking member 43, the support units 21 on the leg units 11 and the poles 41 are pivoted and folded inwardly (as shown in FIG. 6), so that the overall size of the conga stand can be reduced greatly, which is beneficial for subsequent shipment packaging or storage.

What is claimed is:

1. A foldable conga stand, comprising at least three leg units, the leg units each having a support unit thereon, a connecting unit being connected between every adjacent two of the leg units;
the leg units each including a main rod fixedly connected to the connecting unit, a pole being connected to a lower end of the main rod, an upper end of the main rod having an upper joint portion, the support unit having a first movable elbow portion, the first movable elbow portion of the support unit being pivotally connected to the upper joint portion so that the support unit is pivotal relative to the main rod, the support unit further having a support arm extending from the first movable elbow portion and an elongate support member pivoted to a distal end of the support arm, the support member being pivotable relative to the support arm.

2. The foldable conga stand as claimed in claim 1, wherein a first locking member consisting of a locking bolt and a nut is inserted through the upper joint portion and the first movable elbow portion, so that the first movable elbow portion and the upper joint portion are pivotally connected to each other.

3. The foldable conga stand as claimed in claim 2, wherein mating end faces of the upper joint portion and the first movable elbow portion have annular toothed segments to mesh with each other.

4. The foldable conga stand as claimed in claim 2, wherein the lower end of the main rod has a lower joint portion, an upper end of the pole has a second movable elbow portion that is connected to the lower joint portion, and a second locking member consisting of a locking bolt and a nut is inserted through the lower joint portion and the second movable elbow portion, so that the second movable elbow portion and the lower joint portion are pivotally connected to each other.

5. The foldable conga stand as claimed in claim 4, wherein mating end faces of the lower joint portion and the second movable elbow portion have annular toothed segments to mesh with each other.

6. The foldable conga stand as claimed in claim 1, wherein the support member is in the form of a plate having a U-shaped cross-section, a return spring is provided at a position where the support member is pivotally connected to the support arm, and the return spring is configured for pushing the support member to form an inclined angle between the support member and the support arm.

7. The foldable conga stand as claimed in claim 6, wherein one end face of the support member, facing away from the support arm, forms a support area for holding an outer peripheral surface of a conga, and an anti-slip pad made of a soft material is provided on the support area.

8. The foldable conga stand as claimed in claim 1, wherein the connecting unit includes a clamping ring fixed on the main rod and a connecting rod transversely connected between the clamping rings on the main rods of the adjacent leg units.

9. The foldable conga stand as claimed in claim 1, wherein the pole is in the form of a hollow tube, a telescopic pole is telescoped in the pole, the telescopic pole is slidable relative to the pole, and an annular fastening member is provided at a position where the telescopic pole is telescoped to the pole for fastening the telescopic pole.
